(19) United States
(12) Patent Application Publication
(10) Pub. No.: US 2025/0148547 A1
(43) Pub. Date: May 8, 2025

(54) LONG-TERM EFFECT PREDICTION APPARATUS, LONG-TERM EFFECT PREDICTION METHOD, AND PROGRAM

(71) Applicant: NIPPON TELEGRAPH AND TELEPHONE CORPORATION, Tokyo (JP)

(72) Inventors: Machiko SHINOZUKA, Tokyo (JP); Masahiro SOTOMA, Tokyo (JP); Xiaoxi ZHANG, Tokyo (JP); Midori KAWADA, Tokyo (JP); Minako HARA, Tokyo (JP)

(21) Appl. No.: 18/837,330

(22) PCT Filed: Feb. 15, 2022
(86) PCT No.: PCT/JP2022/005900

§ 371 Date: Aug. 9, 2024

(51) Int. Cl. G06Q 50/00

(52) U.S. Cl. CPC G06Q 50/01

(57) ABSTRACT

An object of the present disclosure is to predict a long-term effect of a social event on human behavior.

For this purpose, the present disclosure provides a long-term effect prediction apparatus configured to predict a long-term effect of a social event on human behavior, the long-term effect prediction apparatus including: a relationship analysis unit configured to identify each index of a plurality of popularization factors after occurrence of past social events that promoted popularization of a subject to be analyzed on the basis of at least one of questionnaires and news articles, and quantify each of the indices on the basis of statistical data to obtain a numeric value; a contribution degree calculation unit configured to calculate a relative degree of contribution of each of the indices in the same period in a plurality of periods by performing standard regression analysis on the numeric value during the plurality of periods; and a scenario generation unit configured to generate a future prediction value of each of the indices on the basis of past transition in a degree of contribution of each the indices during the plurality of periods.

### TECHNICAL FIELD

The present disclosure relates to a future prediction technique, and particularly to a technique of predicting the effect of vast social events on people in the long term.

### BACKGROUND ART

Large-scale social events such as disasters, economic crises, or infectious diseases occur every few years to several decades. These social events affect people's lives and can lead to social transformation in the long term. For example, Covid-19 has restricted people's behavior, which has led to increased use of online activities for work, shopping, and the like.

In addition, there have been numerous short-term analyses of social events immediately after the occurrence of social events until now. For example, NPL 1 discloses simulation of people's evacuation behavior in a plurality of evacuation patterns in order to design an evacuation guidance method in the event of an earthquake.

Further, NPL 2 discloses simulation of the long-term effect of regional ups and downs due to changes in economic conditions on population migration. Each individual (agent) determines scores of a plurality of potential destinations to determine the destination. Although personal attributes are reflected in human behavior or decision-making rules, reactions to situations are considered to be constant regardless of time or experience.

In addition, NPL 3 discloses that immediately after a social event occurs, people can be expected to behave in accordance with commands, but as the effects last longer and experience accumulates, stress and habituation arise, which is reflected in behavior.

### CITATION LIST

### Non Patent Literature

[NPL 1] Nakashima et al., “A Study of the Ratio of Irrational Evacuation and the Transition in the Number of Victims in Matsuyama Castle-Evacuation Simulation by Multi-Agent System-,” Journal of Disaster Mitigation for Historical Cities, vol. 12, pp. 1-6, 2018
[NPL 2] Imao et al., “The Applicability of Multi-Agent Simulation to the Demographic Shift,” Proceedings of infrastructure planning, vol. 32, No. 76, pp. 1-4, 2005
[NPL 3] Health Management Information <2021 No. 1> Corporate mental health care during the coronavirus pandemic <https://www.irric.co.jp/pdf/risk_info/health/2021_01.pdf>

### SUMMARY OF INVENTION

### Technical Problem

However, while there have been so far numerous analyses of people's short-term behavior after the occurrence of social events such as evacuation behavior during an earthquake, there has been little quantitative analysis of long-term changes in behavior and habits. Particularly, in planning long-term countermeasures against a certain social event, it is a challenge to analyze not only the immediate aftermath of the event, but also changes in people's reactions.

The present invention was contrived in view of the above points, and an object thereof is to predict a long-term effect of a social event on human behavior.

### Solution to Problem

In order to solve the above problem, according to the invention of claim 1, there is provided a long-term effect prediction apparatus configured to predict a long-term effect of a social event on human behavior, the device including: a relationship analysis unit configured to identify each index of a plurality of popularization factors after occurrence of past social events that promoted popularization of a subject to be analyzed on the basis of at least one of questionnaires and news articles, and quantify each of the indices on the basis of statistical data to obtain a numeric value; a contribution degree calculation unit configured to calculate a relative degree of contribution of each of the indices in the same period in a plurality of periods on the basis of the numeric value during the plurality of periods; and a scenario generation unit configured to generate a future prediction value of each of the indices on the basis of past transition in a degree of contribution of each the indices during the plurality of periods.

### Advantageous Effects of Invention

According to the present invention as described above, it is possible to predict a long-term effect of a social event on human behavior.

### BRIEF DESCRIPTION OF DRAWINGS

FIG. 1 is a schematic diagram of a communication system.

FIG. 2 is an electrical hardware configuration diagram of a long-term effect prediction device.

FIG. 3 is an electrical hardware configuration diagram of a communication terminal.

FIG. 4 is a functional configuration diagram of the long-term effect prediction device.

FIG. 5 is a flowchart illustrating a process of predicting long-term effects.

FIG. 6 is a diagram illustrating advantages of telework as an example of news articles.

FIG. 7 is a diagram illustrating reasons for resuming telework as an example of news articles.

FIG. 8 is a diagram illustrating each popularization factor, name, index, and degree of contribution during each period in telework implementation.

FIG. 9 is a diagram illustrating a telework implementation rate for each prefecture during a certain period in the past and a ratio of popularization factors for each index.

FIG. 10 is a diagram illustrating a concept of standard regression analysis.

FIG. 11 is a diagram illustrating a time-series graph showing prediction values as analysis results.

### DESCRIPTION OF EMBODIMENTS

Hereinafter, an embodiment of the present invention will be described with reference to the accompanying drawings.

### [System Configuration of Embodiment]

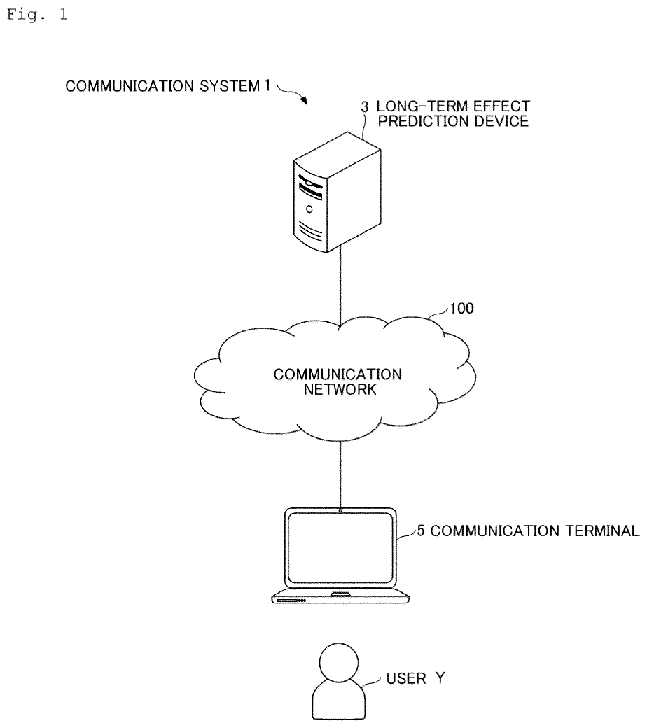

First, the outline of the configuration of a communication system of the present embodiment will be described with reference to FIG. 1. FIG. 1 is a schematic diagram of a communication system according to an embodiment of the present invention.

As shown in FIG. 1, a communication system 1 of the present embodiment is constructed by a long-term effect prediction device 3 (long-term effect prediction apparatus) and a communication terminal 5. The communication terminal 5 is managed and used by a user Y.

In addition, the long-term effect prediction device 3 and the communication terminal 5 can communicate with each other through a communication network 100 such as the Internet. The form of connection of the communication network 100 may be either wireless or wired.

The long-term effect prediction device 3 is constructed by one or a plurality of computers. In a case where the long-term effect prediction device 3 is constructed by a plurality of computers, it may be referred to as a “long-term effect prediction device,” or may be referred to as a “long-term effect prediction system.”

The long-term effect prediction device 3 defines four popularization factors to be described later as motivations for people's behavior, and predicts future behavior and establishment of habits from time-series changes in the degree of contribution of each factor.

The communication terminal 5 is a computer, and FIG. 1 shows a note-type personal computer as an example. In FIG. 1, the user Y operates the communication terminal 5. Meanwhile, the long-term effect prediction device 3 may perform processing alone without using the communication terminal 5.

### [Hardware Configuration]

### <Hardware Configuration of Long-Term Effect Prediction Device>

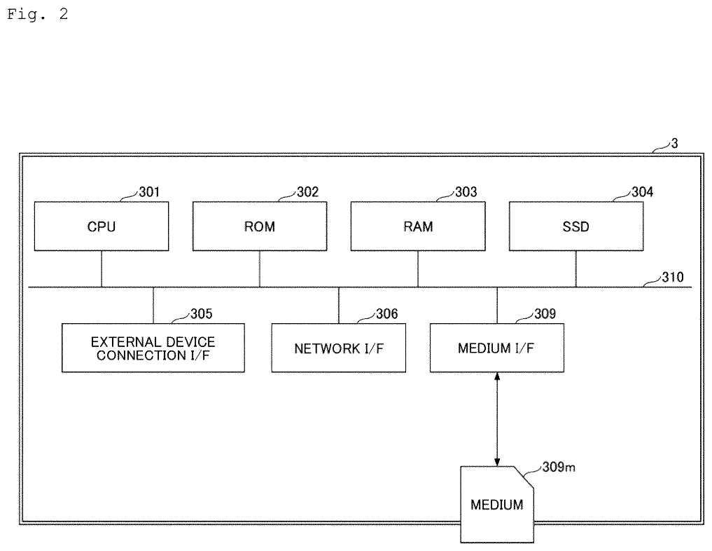

Next, the electrical hardware configuration of the long-term effect prediction device 3 will be described with reference to FIG. 2. FIG. 2 is an electrical hardware configuration diagram of the long-term effect prediction device.

As shown in FIG. 2, the long-term effect prediction device 3 is a computer, and includes a central processing unit (CPU) 301, a read only memory (ROM) 302, a random access memory (RAM) 303, a solid state drive (SSD) 304, an external device connection interface (I/F) 305, a network I/F 306, a medium I/F 309, and a bus line 310.

Among these, the CPU 301 controls the overall operation of the long-term effect prediction device 3. The ROM 302 stores programs used to drive the CPU 301 such as an initial program loader (IPL). The RAM 303 is used as a work area of the CPU 301.

The SSD 304 reads out or writes various types of data in accordance with control of the CPU 301. Meanwhile, a hard disk drive (HDD) may be used instead of the SDD 304.

The external device connection I/F 305 is an interface for connecting various external devices. The external devices in this case are displays, speakers, keyboards, mice, Universal Serial Bus (USB) memories, printers, and the like.

The network I/F 306 is an interface for data communication through the communication network 100.

The medium I/F 309 controls reading-out or writing (storage) of data to a recording medium 309m such as a flash memory. Examples of the recording medium 309m also include a digital versatile disc (DVD), a Blu-ray Disc (registered trademark), and the like.

The bus line 310 is an address bus, a data bus, or the like for electrically connecting each component such as the CPU 301 shown in FIG. 2.

### <Hardware Configuration of Communication Terminal>

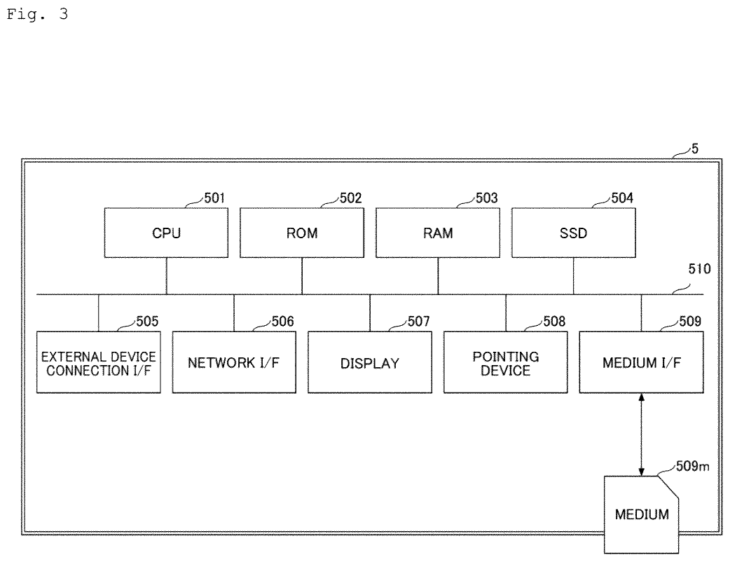

Next, the electrical hardware configuration of the communication terminal 5 will be described with reference to FIG. 3. FIG. 3 is an electrical hardware configuration diagram of the communication terminal.

As shown in FIG. 3, the communication terminal 5 is a computer, and includes a CPU 501, a ROM 502, a RAM 503, an SSD 504, an external device connection interface (I/F) 505, a network I/F 506, a display 507, a pointing device 508, a medium I/F 509, and a bus line 510.

Among these, the CPU 501 controls the overall operation of the communication terminal 5. The ROM 502 stores programs used to drive the CPU 501 such as an IPL. The RAM 503 is used as a work area of the CPU 501.

The SSD 504 reads out or writes various types of data in accordance with control of the CPU 501. Meanwhile, a hard disk drive (HDD) may be used instead of the SSD 504.

The external device connection I/F 505 is an interface for connecting various external devices. The external devices in this case are displays, speakers, keyboards, mice, USB memories, printers, and the like.

The network I/F 506 is an interface for data communication through the communication network 100.

The display 507 is a type of display means such as liquid crystal or organic electro luminescence (EL) that displays various images.

The pointing device 508 is a type of input means for selecting and executing various instructions, selecting a processing target, moving a cursor, and the like. Meanwhile, in a case where the user Y uses a keyboard, the function of the pointing device 508 may be turned off.

The medium I/F 509 controls reading-out or writing (storage) of data to a recording medium 509m such as a flash memory. Examples of the recording medium 509m also include a DVD, a Blu-ray Disc (registered trademark), and the like.

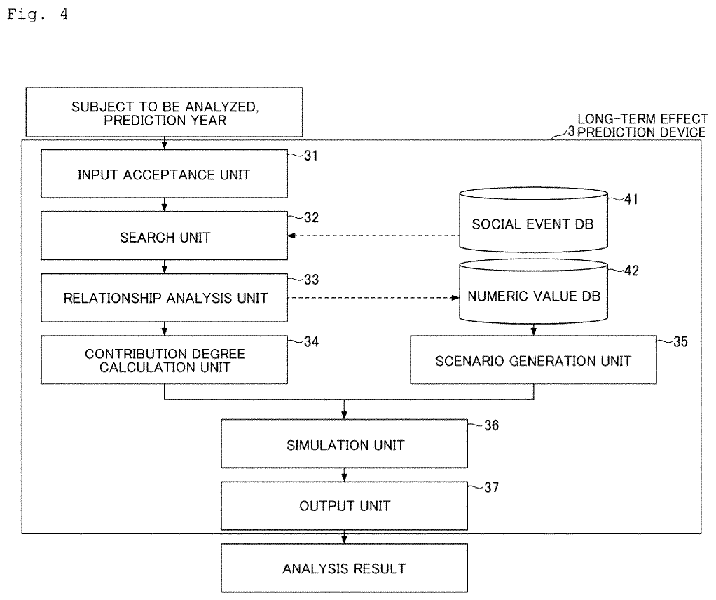

The bus line 510 is an address bus, a data bus, or the like for electrically connecting each component such as the CPU 501 shown in FIG. 4.

### [Functional Configuration of Long-Term Effect Prediction Device]

Next, the functional configuration of the long-term effect prediction device will be described with reference to FIG. 4. FIG. 4 is a functional configuration diagram of the long-term effect prediction device in the embodiment of the present invention.

In FIG. 4, the long-term effect prediction device 3 includes an input acceptance unit 31, a search unit 32, a relationship analysis unit 33, a contribution degree calculation unit 34, a scenario generation unit 35, a simulation unit 36, and an output unit 37. Each of these units is a function realized by orders of the CPU 301 in FIG. 2 on the basis of programs.

Further, a social event database (DB) 41 and a numeric value DB 42 are constructed in the RAM 303 or the HD 304 in FIG. 2.

### <Description of DB>

### (Social Event DB)

In the social event DB 41, social events that occurred in the past and the services, behaviors, and the like popularized as a result of the events are managed in association with each other. For example, the social event is “Covid-19,” and the popularized services, behaviors, and the like are managed as “telework.”

### (Numeric Value DB)

The numeric value DB 42 is a DB for selecting and storing numeric values of indices of a plurality of popularization factors identified by the relationship analysis unit 33 from available information such as statistical data. In the present embodiment, there are four popularization factors, that is, top-down command, personal attribute, reaction to social event, and usage status of subject to be analyzed by nearby people. These are determined in advance and will be described in detail later.

### <Each Functional Configuration>

Subsequently, each functional configuration of the long-term effect prediction device will be described with reference to FIGS. 2 to 4.

The input acceptance unit 31 accepts an input of the name of a product or service to be analyzed and the prediction year from the user Y through the communication terminal 5 and the network I/F 306.

The search unit 32 uses the name of a subject to be analyzed accepted as an input by the input acceptance unit 31 as a search key to search and extract past social events that promoted popularization from the social event DB.

The relationship analysis unit 33 identifies each index for a plurality of popularization factors (such as a top-down command) after the occurrence of a past social event that promoted the popularization of a subject to be analyzed on the basis of at least one of questionnaires and news articles, and quantifies each of the indices on the basis of statistical data to obtain a numeric value. In addition, the relationship analysis unit 33 stores the numeric value of each index in the numeric value DB 42.

The contribution degree calculation unit 34 calculates the relative degree of contribution of each index in the same period in a plurality of periods by performing standard regression analysis on numeric values in a plurality of periods. The “period” is represented by a period such as, for example, a period of several years, one year, half a year, each season of spring, summer, fall, and winter, three months such as a quarter, one month, or one week.

The scenario generation unit 35 uses the indices of popularization factors for a plurality of periods stored in the numeric value DB 42 and the degree of contribution calculated by the contribution degree calculation unit 34 to generate a future prediction value of each of the indices on the basis of the past transition in the degree of contribution of each of the indices for a plurality of periods (past time-series transition).

The simulation unit 36 calculates the future popularization rate or usage rate of the subject to be analyzed through agent simulation or the like, and generates a graph of time-series changes.

The output unit 37 outputs analysis results such as a graph of time-series changes. Examples of output methods include transmitting, displaying, or printing data of the output result to the communication terminal 5.

### [Processing or Operation of Embodiment]

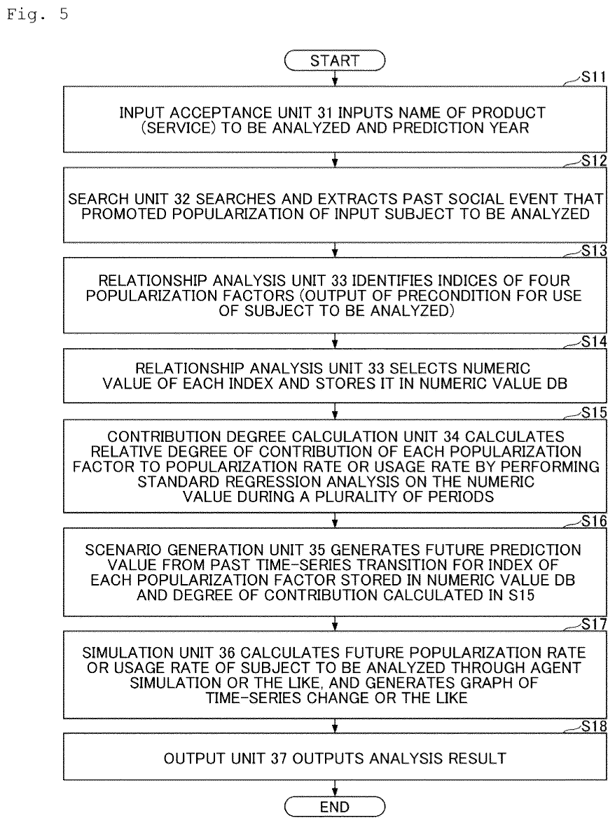

Subsequently, the processing or operation of the present embodiment will be described in detail with reference to FIGS. 5 to 11. FIG. 5 is a flowchart illustrating a process of predicting long-term effects.

As shown in FIG. 5, the input acceptance unit 31 first accepts an input of the name of a product or service to be analyzed and each piece of data of the prediction year (for example, 140 months from April 2022) from the user Y through the communication terminal 5 (S11).

Next, the search unit 32 uses the name accepted in step S11 as a search key to search the social event DB 41 for past social phenomena that promoted the popularization of the subject to be analyzed, and extracts the past social phenomena from the social event DB 41 (S12). Here, a case where “telework” is input in step S11 and “Covid-19 epidemic” is extracted in step S12 will continue to be further described.

The relationship analysis unit 33 identifies the indices of the four specific popularization factors to be analyzed after the occurrence of the social event extracted in step S12 by performing text analysis on at least one of questionnaires and news articles, or the like (S13). In addition, when there is a precondition (such as a personal attribute) for the use of the subject to be analyzed, the relationship analysis unit 33 delivers the precondition to the simulation unit 36.

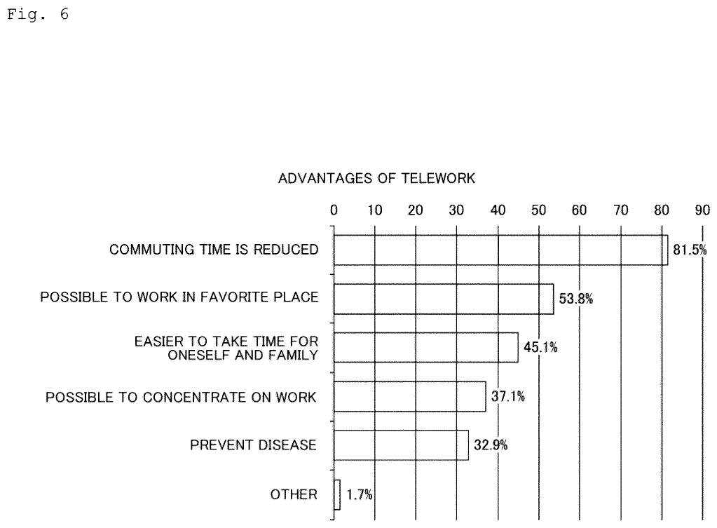

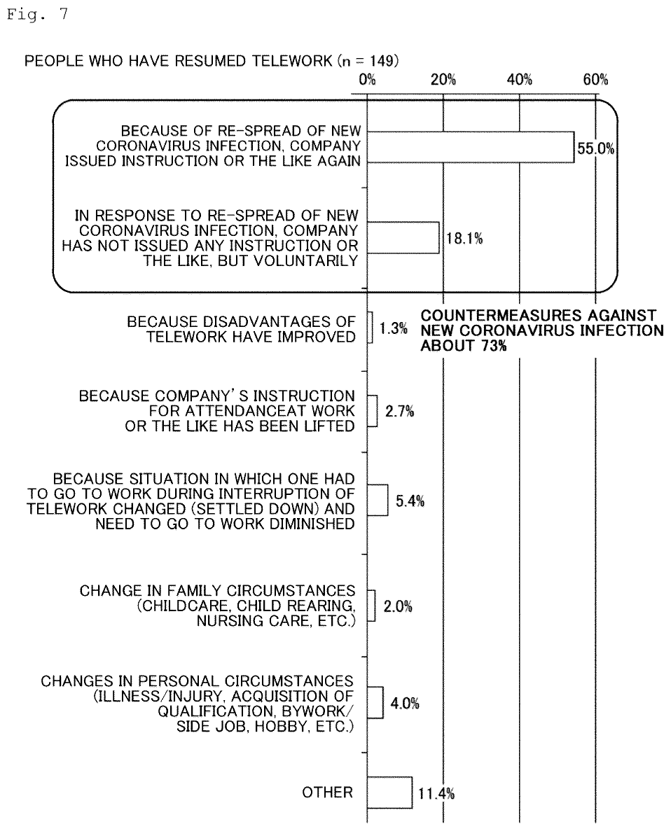

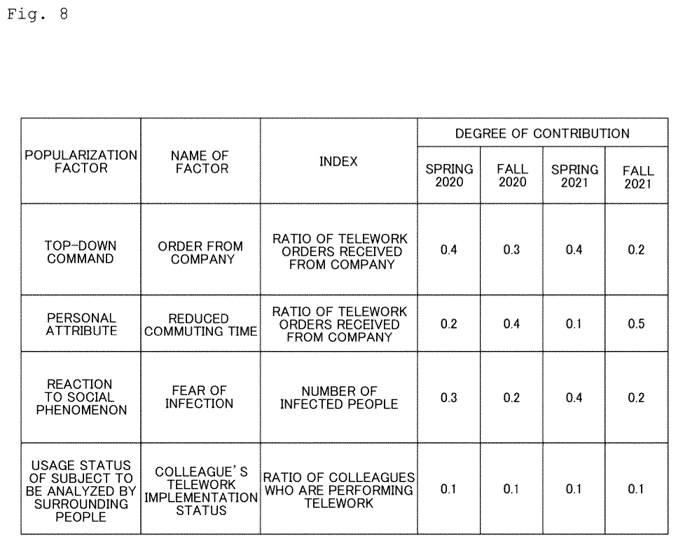

FIG. 6 is a diagram illustrating advantages of telework as an example of news articles. FIG. 7 is a diagram illustrating reasons for resuming telework as an example of news article. For example, the relationship analysis unit 33 identifies the indices of popularization factors by performing text analysis on articles and the like shown in FIGS. 6 and 7. Thereby, the relationship analysis unit 33 can identify the index of each of the four popularization factors as shown in FIG. 8. Here, the index of the popularization factor “top-down command” is the “ratio of telework orders received from the company.” The index of the popularization factor “personal attribute” is “commuting time.” The index of the popularization factor “reaction to a social event” is “the number of infected people.” The index of the popularization factor “usage status of subject to be analyzed by nearby people” is the “ratio of colleagues who are performing telework.” Meanwhile, FIG. 8 also shows the name of each popularization factor (such as “order from company”) for reference.

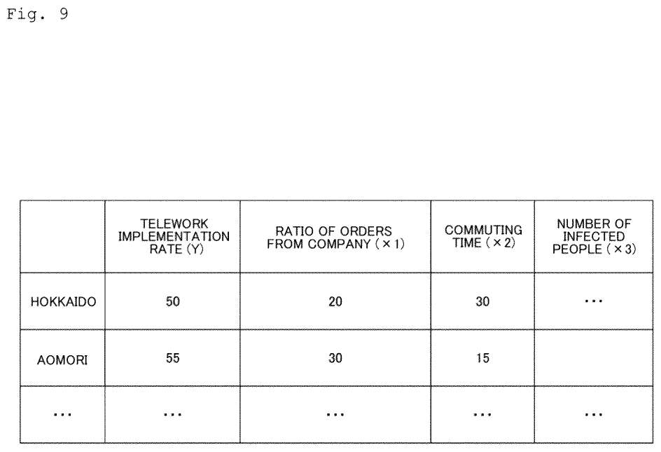

Next, the relationship analysis unit 33 uses a method such as text analysis to select numeric values indicating each index of a plurality of (here, four) popularization factors identified in step S13 from available information such as statistical data, and stores them in the numeric value DB 4002 (S14). Meanwhile, in a case where a plurality of candidates are detected, the relationship analysis unit 33 selects the relationship with the popularization rate or usage rate of the subject to be analyzed, for example, the one with the highest correlation coefficient. Here, the relationship analysis unit 33 quantifies the index of each popularization factor in order to obtain the relative degree of contribution of each popularization factor identified in step S13 to the telework implementation rate. The relationship analysis unit 33 converts the title and numeric value name of published statistical information and the name of each popularization factor into word vectors, and selects an index with a close vector distance for each popularization factor. In a case where there are a plurality of candidates, the relationship analysis unit 33 selects a candidate having the highest correlation coefficient with the telework implementation rate. Here, as shown in FIG. 8, in order to calculate the relative degree of contribution of each index for a plurality of periods (spring 2020, fall 2020, spring 2021, and fall 2021), the numeric values in units of prefectures are collected and stored in the numeric value DB as shown in FIG. 9. FIG. 9 is a diagram illustrating a telework implementation rate for each prefecture during a certain period in the past and a ratio of popularization factors for each index. FIG. 9 shows a telework implementation rate for each prefecture and a ratio for each index of popularization factors in past periods such as spring 2020. Meanwhile, regarding the “ratio of colleagues who are performing telework” among the four indices, it is difficult to ascertain the behavior of colleagues who are strangers unlike one's own behavior, and thus numeric values are not collected.

Next, the contribution degree calculation unit 34 calculates the relative degree of contribution of each popularization factor to the popularization rate or usage rate, for example, through standard regression analysis (partial regression analysis) (S15). This calculation is performed on at least any two periods (for example, spring 2020 and fall 2020) in order to express the relationship between the degree of contribution and the change in time. Meanwhile, the degree of contribution of some popularization factors may be fixed at a constant value, and the degree of contribution of other factors may be prorated from the analysis results so that the total degree of contribution is 100%. Here, the contribution degree calculation unit 34 calculates the relative degree of contribution of each popularization factor by performing standard regression analysis in a plurality of periods with the index selected in step S14 as an explanatory variable and the telework implementation rate as an objective variable. Meanwhile, since the numeric values of the indices are not collected for the telework implementation status of colleagues as described above, the contribution degree calculation unit 34 calculates them endogenously using a simulation model and fixes the degree of contribution to the determination of the individual's telework implementation rate at 0.1. The remaining three factors (ratio of telework orders received from the company, commuting time, and the number of infected people) are prorated in the degree of contribution, as shown in FIG. 8, from the results obtained through standard regression analysis so that the total is 0.9.

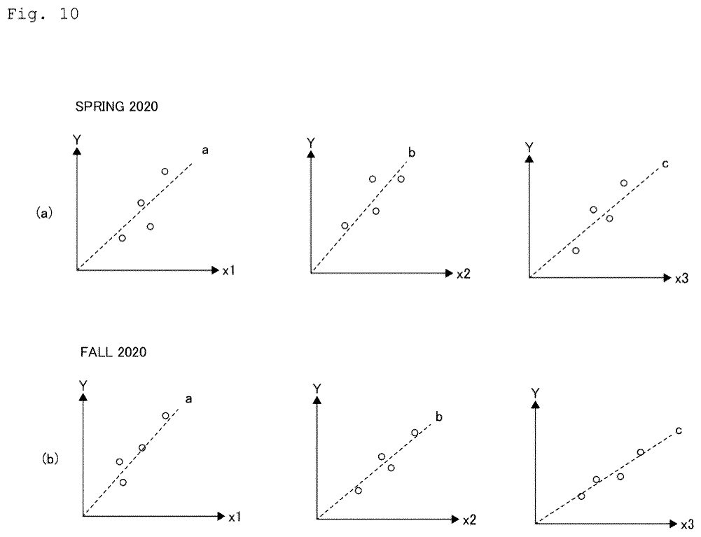

Here, the concept of standard regression analysis will be described with reference to FIGS. 9 and 10. FIG. 10 is a diagram illustrating the concept of standard regression analysis. As shown in FIG. 9, when the individual's telework implementation rate is Y, the ratio of orders from the company is x1, the commuting time is x2, and the number of infected people is x3, Y is represented by the following (Expression 1).

$$Y = ax 1 + bx 2 + cx 3 \qquad ( Expression 1 )$$

Here, a, b, and c are constants, and the contribution degree calculation unit 34 obtains each constant. FIG. 10(a) shows data for spring 2020. For example, as shown in FIG. 10(a), in the graph showing the relationship between the telework implementation rate Y and the “ratio of orders from the company” x1 for each prefecture, the average value (dashed line) is the constant a, that is, the degree of contribution. Meanwhile, there are 47 prefectures in Japan, but they are simplified to four in the flag. Similarly, as shown in FIG. 10(a), in the graph showing the relationship between the telework implementation rate Y and the “commuting time” x2 for each prefecture, the average value (dashed line) is the constant b, that is, the degree of contribution. Similarly, as shown in FIG. 10(a), in the graph showing the relationship between the telework implementation rate Y and “the number of infected people” x3 for each prefecture, the average value (dashed line) is the constant c, that is, the degree of contribution. In reality, the three graphs in FIG. 8(a) are represented by one multidimensional graph, but they are divided into three and represented here for ease of understanding.

FIG. 10(b) shows data of fall 2020. Here, the constants a, b, and c, that is, the degrees of contribution are also calculated in the same way as in spring 2020. In this way, the degree of contribution of each index calculated by the contribution degree calculation unit 34 in the four periods of spring 2020, fall 2020, spring 2021, and fall 2021 is shown in FIG. 8. As described above, the degree of contribution of the index “ratio of colleagues who are performing telework” is fixed at 0.1.

Next, the scenario generation unit 35 generates future prediction values from the past time-series transition on the basis of the index of each popularization factor stored in the numeric value DB 4002 and the degree of contribution of each period calculated in step S15 (S16).

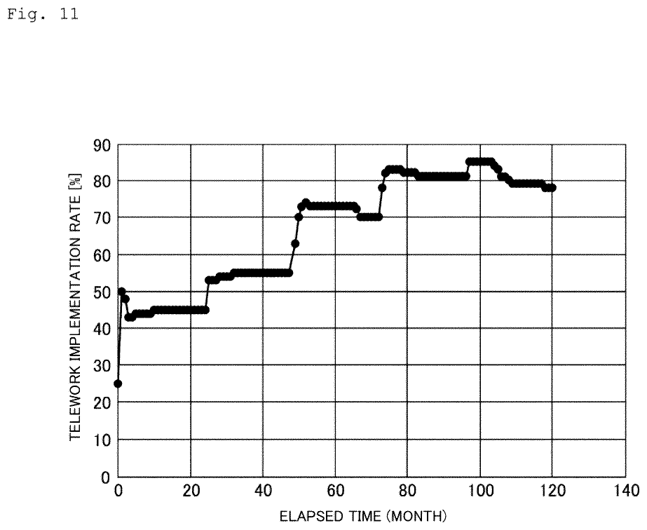

Next, the simulation unit 36 calculates the future popularization rate or usage rate of the subject to be analyzed through agent simulation or the like, and generates a graph of time-series changes as shown in FIG. 11 (S17). FIG. 11 is a diagram illustrating a time-series graph showing prediction values as analysis results. According to this, the telework implementation rate is predicted to gradually increase over the next 120 months.

Finally, the output unit 37 outputs the analysis results such as a graph of time-series changes. Examples of an output method include transmitting, displaying, or printing data of the output results to the communication terminal 5.

### Effects of Embodiment

As described above, according to the present embodiment, it is possible to predict a long-term effect of a social event on human behavior, taking into account people's emotions and experiences.

In addition, the ability to make longer-term prediction is expected to lead to more effective policy decisions.

### [Supplement]

The present invention is not limited to the above-described embodiment, and may have the following configuration or processing (operation).

(1) The long-term effect prediction device 3 can also be realized by a computer and a program, but this program can also be recorded in a (non-transitory) recording medium or provided through the communication network 100.

(2) Another device (such as a server or a router) may relay data in communication between the long-term effect prediction device 3 and the communication terminal 5. For example, in the present specification, for the sake of simplicity, it is stated that the input acceptance unit 31 of the long-term effect prediction device 3 transmits data to the communication terminal 5, but this transmission process is also intended to include a case where another device relays data.

(4) In the above embodiment, a note-type personal computer is shown as an example of the communication terminal 5, but there is no limitation thereto, and may be, for example, a desktop personal computer, a tablet terminal, a smartphone, a smartwatch, a car navigation device, a refrigerator, a microwave oven, or the like.

(5) Each of the CPUs 301 and 501 may be not only single but also multiple.

(6) A neural network may be used in at least one of the calculations executed by the relationship analysis unit 33. In addition, a neural network may be used instead of using the method of standard regression analysis in the calculation of the degree of contribution executed by the contribution degree calculation unit 34.

### REFERENCE SIGNS LIST

1 Communication system
3 Long-term effect prediction device
5 Communication terminal
31 Input acceptance unit
32 Search unit
33 Relationship analysis unit
34 Contribution degree calculation unit
35 Scenario generation unit
36 Simulation unit
37 Output unit
41 Social event DB
42 Numeric value DB

1. A long-term effect prediction apparatus configured to predict a long-term effect of a social event on human behavior, the long-term effect prediction apparatus comprising:
a processor; and
a memory that includes instructions, which when executed, cause the processor to execute:
identifying each index of a plurality of popularization factors after occurrence of past social events that promoted popularization of a subject to be analyzed on the basis of at least one of questionnaires and news articles, and quantifying each of the indices on the basis of statistical data to obtain a numeric value;
calculating a relative degree of contribution of each of the indices in the same period in a plurality of periods on the basis of the numeric value during the plurality of periods; and
generating a future prediction value of each of the indices on the basis of past transition in a degree of contribution of each the indices during the plurality of periods.

2. The long-term effect prediction apparatus according to claim 1, wherein the calculating includes calculating a relative degree of contribution of each of the indices in the same period in the plurality of periods by performing standard regression analysis on the numeric value during the plurality of periods.

3. The long-term effect prediction apparatus according to claim 1, wherein the plurality of popularization factors are a top-down command, a personal attribute, a reaction to a social event, and a usage status of a subject to be analyzed by nearby people.

4. The long-term effect prediction apparatus according to claim 3, wherein the degree of contribution to the usage status of a subject to be analyzed by the nearby people is fixed to a constant value.

5. The long-term effect prediction apparatus according to claim 1, wherein the instructions, which when executed, cause the processor to execute: calculating a future popularization rate or usage rate of the subject to be analyzed on the basis of the prediction value generated at the generating and generating an analysis result indicating a time-series change.

6. The long-term effect prediction apparatus according to claim 5, wherein the generating includes calculating the future popularization rate or usage rate of the subject to be analyzed through agent simulation.

7. A long-term effect prediction method executed by a long-term effect prediction apparatus that predicts a long-term effect of a social event on human behavior, the method comprising causing the long-term effect prediction apparatus to execute:
identifying each index of a plurality of popularization factors after occurrence of past social events that promoted popularization of a subject to be analyzed on the basis of at least one of questionnaires and news articles, and quantifying each of the indices on the basis of statistical data to obtain a numeric value;
calculating a relative degree of contribution of each of the indices in the same period in a plurality of periods on the basis of the numeric value during the plurality of periods; and
generating a future prediction value of each of the indices on the basis of past transition in a degree of contribution of each the indices during the plurality of periods.

8. A non-transitory computer-readable recording medium having computer-readable instructions stored thereon, which when executed, cause a computer to execute the method according to claim 7.
